(19) United States
(12) Patent Application Publication
(10) Pub. No.: US 2008/0230362 A1
(43) Pub. Date: Sep. 25, 2008

(54) MEMBRANE SWITCH

(75) Inventor: Fong-Chi Hsu, Taipei Hsien (TW)

Correspondence Address: J C PATENTS, INC., 4 VENTURE, SUITE 250, IRVINE, CA, 92618, US

(73) Assignee: JENSIN INTL TECHNOLOGY CORP., Taipei County (TW)

(21) Appl. No.: 12/047,089

(22) Filed: Mar. 12, 2008

(30) Foreign Application Priority Data
Mar. 23, 2007 (TW) 96110073

(51) Int. Cl. H01H 1/10

(52) U.S. Cl. 200/512

(57) ABSTRACT

A membrane switch including a first film, a second film and an insulating layer is provided. The first film has a first circuit, a first outlet cable and a second outlet cable. The first circuit is electrically connected with the first outlet cable, and the second outlet cable is disposed adjacent to the first outlet cable. A single outlet joint is formed from the first and second outlet cables. The second film has a second circuit and an outlet terminal, wherein the outlet terminal is electrically connected to the second circuit. The insulating layer is disposed between the first film and the second film so that the first film and the second film are electrically insulated. The outlet terminal is electrically connected to the second outlet cable. The membrane switch is economical and meets the needs of customers.

### CROSS-REFERENCE TO RELATED APPLICATION

This application claims the priority benefit of Taiwan application serial no. 96110073, filed on Mar. 23, 2007. The entirety the above-mentioned patent application is hereby incorporated by reference herein and made a part of specification.

### BACKGROUND OF THE INVENTION

1. Field of the Invention

The present invention relates to a membrane switch. More particularly, the present invention relates to a membrane switch applied on keys or keyboards.

2. Description of Related Art

Generally, a common human device interface should be used when a user want to use an electronic device includes a mouse, a keyboard and a handwriting/speech recognition system or a touch screen etc., operation of the programs of the electronic device has to be performed through the aforementioned human interface device.

Taking a keyboard as an example, when a user operates an electronic device by inputting instructions through a keyboard, the key upon being depressed touches a membrane switch inside the keyboard, and the membrane switch is electrically turned on for outputting the electronic signal to the electronic device.

FIG. 1 is an exploded schematic diagram of a conventional membrane switch. Referring to FIG. 1, a conventional membrane switch 100 includes: a first film 110 and a second film 120 respectively having a plurality of contacts 112 and 122 corresponding to the keys of a keyboard; circuits 114 and 124 connected to the contacts 112 and 122; and outlet joints 116 and 126 connected correspondingly to the circuits 114 and 124, wherein the outlet joints 116 and 126 are electrically connected with the electronic device.

Generally, the layouts of the first film 110 and the second film 120 relate to each other. In other words, most of the contacts 112 and 122 of the first and second films are generally disposed correspondingly. Moreover, an insulating layer 130 is disposed between the first film 110 and the second film 120, such that the contacts 112 and 122, the circuits 114 and 124, the outlet joints 116 and 126 are electrically insulated with each other. In addition, the insulating layer 130 has a plurality of through holes 132 for the contacts 112 and 122 contacting each other when being depressed.

When a user presses a key, the contacts 112 and 122 are electrically turned on while they contact each other, and an electronic signal is generated and transmitted to the outlet joints 116 and 126 through the circuits 114 and 124 disposed individually on the first and second films 110 and 120. Then, the electronic signal is transmitted to the electronic device through the two outlet joints 116 and 126.

However, to connect two outlet joints with the electronic device may increase the assembling time of a keyboard and decrease the productivity. When the customers do not need keyboards having two outlet joints, the whole production line has to be stopped, and the design of the circuit and outlet joint inside the keyboard has to be renewed to meet the requirement of customers, the cost will be expensive, and it is not economical. Thus, how to improve the design under an existing lay out design to meet the requirement of the customers is a major issue.

### SUMMARY OF THE INVENTION

The present invention is directed to a cost effective membrane switch which meets the requirement of the customers without changing an existing layout design.

The present invention provides a membrane switch comprising: a first film, a second film and an insulating layer. The first film comprises a first circuit, a first outlet cable and a second outlet cable. The first circuit is electrically connected to the first outlet cable, and the second outlet cable is disposed adjacent to the first outlet cable. A single outlet joint is formed from the first and second outlet cables. The second film has a second circuit and an outlet terminal, wherein the outlet terminal is electrically connected to the second circuit. The insulating layer is disposed between the first film and the second film, wherein the outlet terminal is electrically connected with the second outlet cable.

In an embodiment of the present invention, the first and second circuits respectively include a plurality of contacts and a plurality of leads connected to the contacts.

In an embodiment of the present invention, the materials of the aforementioned contacts and leads include silver paste.

In an embodiment of the present invention, the first and second circuits comprise a contacting layer disposed on the surface of the contacts.

In an embodiment of the present invention, the contacting layer includes graphite.

In an embodiment of the present invention, the insulating layer may be light curable adhesive, self-adhesive tape or hot embossing adhesive.

In an embodiment of the present invention, the aforementioned insulating layer has a plurality of openings respectively disposed between the corresponding two contacts.

In an embodiment of the present invention, the aforementioned membrane switch comprises a waterproof layer disposed inside the insulating layer.

In the membrane switch of the present invention, the outlet terminal of the second film is electrically connected to the second outlet cable of the first film, such that the electronic signal from the second circuit is transmitted to the electronic device not through two conventional independent outlet joints, but through a single outlet joint formed by the first and second outlet cables. Thus, there is no need of changing the existing design of the layout, and the membrane switch of the present invention is economical and meets the needs of customers.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is an exploded schematic diagram of a conventional membrane switch.

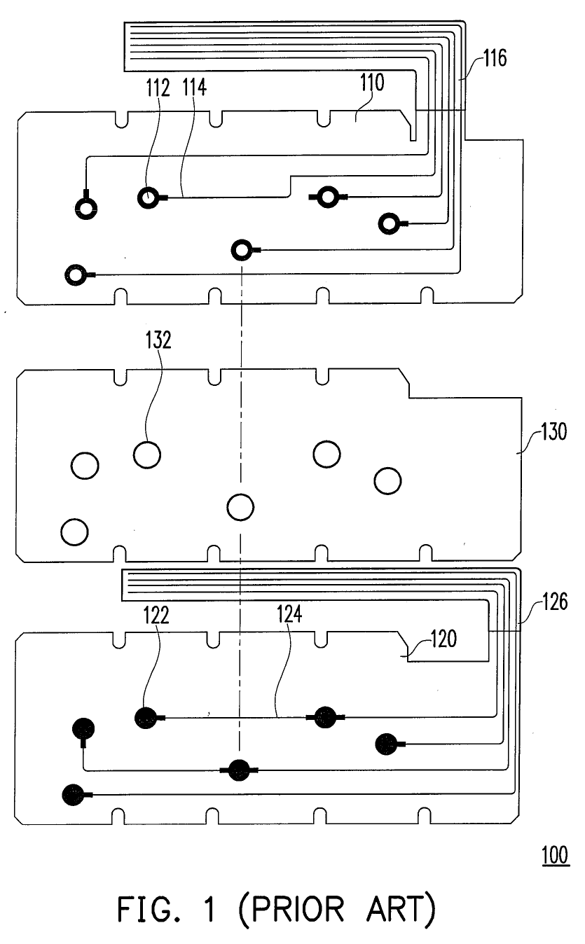

FIG. 2 is an exploded schematic diagram of a membrane switch according to an embodiment of the present invention.

### DESCRIPTION OF EMBODIMENTS

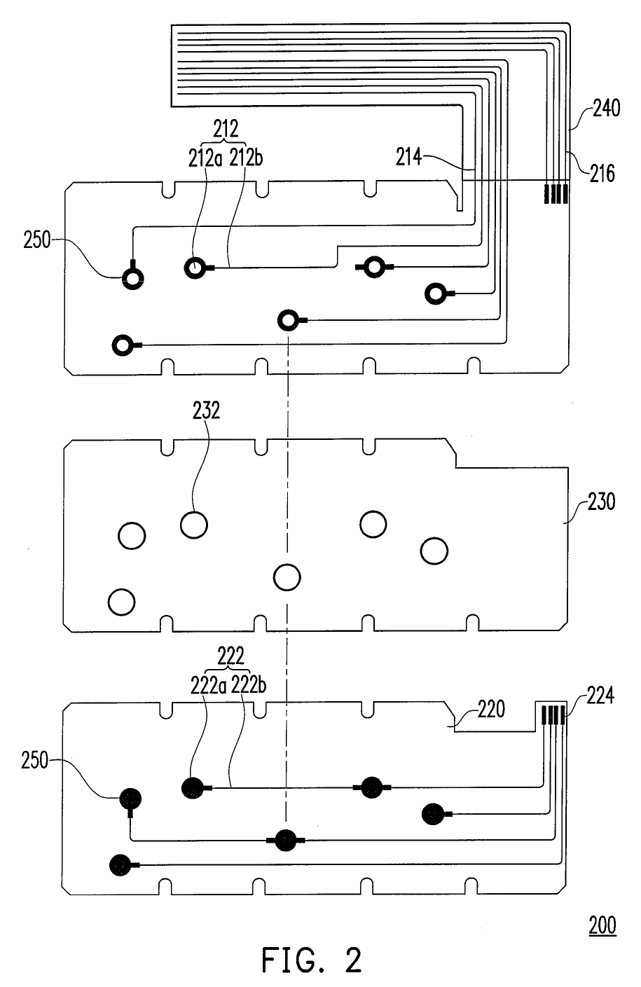

FIG. 2 is an exploded schematic diagram of a membrane switch according to an embodiment of the present invention. Referring to FIG. 2, the membrane switch 200 of the present embodiment includes a first film 210, a second film 220 and an insulating layer 230 disposed between the first film 210 and the second film 220. The material of the first film 210 is same to that of second film 220, and the material of the insulating layer 230 may be light curable adhesive, self-adhesive tape or hot pressing adhesive. Besides being disposed between the first film 210 and the second film 220 as a single sheet, the insulating layer 230 may be directly coated on the first film 210 and/or the second film 220.

More specifically, the first film 210 comprises a first circuit 212, a first outlet cable 214 and a second outlet cable 216. The second film 220 has a second circuit 222 and an outlet terminal 224. The first circuit 212 has a plurality of contacts 212a and a plurality of leads 212b connected to the contacts 212a. The second circuit 222 has a plurality of contacts 222a and a plurality of leads 222b connected to the contacts 222a. In the present embodiment, the contacts 212a and 222a, and the leads 212b and 222b may be comprised of silver, copper foil or other metals with a good conductivity.

Referring to FIG. 2 again, the insulating layer 230 further has a plurality of openings 232 corresponding to the contacts 212a and 222a come in contact therewith when being pressed, the openings 232 are respectively disposed between the corresponding two contacts 212a and 222a. Moreover, a contacting layer 250 may be further coated on the surface of the contacts 212a and 222a to ensure the contacts 212a and 222a a good conductivity and a longer service life, the contacting layer 250 may be comprised of graphite.

It should be noted that the outlet terminal 224 of the present embodiment may be electrically connected to the second outlet cable 216 through a thermal compression bonding process, or the outlet terminal 224 may be electrically connected to the corresponding second outlet cable 216 directly by using an anisotropic conductive adhesive. Therefore, when a user presses a key of the keyboard, the contact 212a contacts the contact 222a and generate an electrical signal, and the electrical signal is transmitted to the electronic device through the leads 212b and 222b respectively (not shown).

Different from the conventional techniques, when the lead 222b transmits the electronic signal to the outlet terminal 224, since the outlet terminal 224 is electronically connected to the second outlet cable 216, the electrical signal from the lead 222b will finally be transmitted to the electronic device through the second outlet cable 216. Meanwhile, the electronic signal is transmitted through a single outlet joint 240 formed by the first outlet cable 214 and the second outlet cable 216, not through two independent outlets joint as in a conventional membrane switch, such that the needs of customers can be met without changing the existing layout design. Thus, there is no need to implement complicated operations such as changing an existing layout design or adding a jumper, and therefore, the layout, stencil fabrication and the following-up electricity assessment may be simplified, and the cost can be reduced. Moreover, since the single outlet joint 240 may be assembled in a single process, the time needed for assembling the keyboard to the electronic device can be effectively reduced.

In addition, a waterproof layer (not shown) may be formed on the surface of the first film 210 and the second film 220 to increase the waterproof capability of the membrane switch 200, and accordingly the membrane switch may be rendered water resistant and have a long service life.

In summary, the present invention improves the design of a conventional membrane switch having two outlet joints by electrically connecting the outlet terminal of the second film with the second outlet cable and transmitting the electronic signal through a single outlet joint formed by the first and second outlet cables. Therefore, the membrane switch of the present invention provides an improved design of the outlet cables based on an existing layout such that the original production line may be able to produce both the membrane switch having two outlet joints and the membrane switch having the improved outlet cables, and accordingly, the membrane switch is economical and meets the needs of customers. Moreover, since there is no need to add any jumpers in the membrane switch of the present invention, the shortage of adding jumpers in the conventional membrane switch is overcame, and the fabrication process is simplified accordingly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A membrane switch, comprising:
a first film, having a first circuit, a first outlet cable and a second outlet cable, the first circuit being electrically connected to the first outlet cable, and the second outlet cable being disposed adjacent to the first outlet cable;
a second film, disposed on one side of the first film, having a second circuit and an outlet terminal, the outlet terminal being electrically connected to the second circuit; and
an insulating layer, disposed between the first film and the second film, the outlet terminal being electrically connected to the second outlet cable.

2. The membrane switch as claimed in claim 1, wherein the first circuit and the second circuit comprise a plurality of contacts and a plurality of leads connected to the contacts.

3. The membrane switch as claimed in claim 2, wherein the materials of the contacts and leads comprise silver paste.

4. The membrane switch as claimed in claim 3, wherein the first circuit and the second circuit comprise a contacting layer disposed on the surface of the contacts.

5. The membrane switch as claimed in claim 4, wherein the material of the contacting layer comprises graphite.

6. The membrane switch as claimed in claim 1, wherein the insulating layer is light curable adhesive, self-adhesive tape or hot embossing adhesive.

7. The membrane switch as claimed in claim 1, wherein the insulating layer has a plurality of openings respectively disposed between the corresponding two contacts.

8. The membrane switch as claimed in claim 1, further comprising a waterproof layer disposed inside the insulating layer.
